(19) United States
(12) Patent Application Publication
(10) Pub. No.: US 2016/0050308 A1
(43) Pub. Date: Feb. 18, 2016

(54) MOVEMENT-BASED, USER IDENTITY AUTHENTICATED UNLOCKING AND LOCKING TRIGGERS FOR SMARTPHONES AND WEARABLE MOBILE DEVICES

(71) Applicants: Chang Liu, Athens, OH (US); Siang Lee Hong, Canal Winchester, OH (US)

(72) Inventors: Chang Liu, Athens, OH (US); Siang Lee Hong, Canal Winchester, OH (US)

(21) Appl. No.: 14/458,605

(22) Filed: Aug. 13, 2014

(51) Int. Cl. H04M 1/725; H04W 12/08; H04M 1/73; H04W 52/02

(52) U.S. Cl. CPC H04M 1/72577; H04W 52/0209; H04W 12/08; H04M 1/73

(57) ABSTRACT

A system for locking and unlocking the display of a smartphone or wearable mobile device, which includes the use of a unique movement-based identifier contained on the device. For unlocking, if the person can reproduce the input movement with similar enough characteristics to a reference movement stored on the phone, or to a previous input movement stored in the database, then the person is authenticated and the phone is unlocked. If there is insufficient similarity between reference and input, or if the input movement data exactly match the reference or any stored movement, the user is not authenticated and the smartphone remains locked. For locking, the person will move the smartphone into a position where the display would no longer be visible to the user. When such an event is detected, the smartphone will power itself down.

### BACKGROUND OF THE INVENTION

To conserve power and extend battery life, individuals who own smartphones or wearable devices (for example, but not limited to devices such as a smartwatch) regularly turn off or lock the display and touchscreen when the device is not in use. This action also protects the display from burning out, extending the life of the mobile device itself. To shut off or lock the display, a simple user action such as pressing the “power” button or a set predefined inactivity period is sufficient. To use a phone after the display has been powered down or shut off, usually more effort is needed for the individual owner of the mobile device to “wake up” and unlock it to access features on the phone.

Conventional methods require explicit actions from individuals to perform the “wake up” function of the mobile device and access the other functions of the mobile device. Conventional wake up activation involves the pressing of a specific button on the phone, or generating a particular gesture, such as sliding the finger from left to right. These existing “wake up” methods are fairly complicated in terms of steps. First, the power button must be pressed. Because the power button could be pressed by accident when a phone is in a pocket or a purse, additionally steps are often required to unlock the phone. For example, next, the mobile device needs to be moved into an appropriate position at which the display is visible to the individual who is using the mobile device. After that, the user must then produce the necessary unlocking gesture or button press. Typically, only once these three steps have been completed can the individual gain access to the functions of the phone. While there are methods to increase convenience by reducing the number of steps to unlocking the mobile device, they are often less secure and are more likely to lead to accidental, undesired activation of the mobile device.

There has been one invention that has attempted to utilize the motions of the smartphone for the purpose of controlling the functions of the phone, namely Chinese Patent No. 101,976,330B. This patent provides a method for the extraction of features of a gesture performed by a user of a mobile device to enhance user experience. The existing patent invention is not able to detect specific events that indicate the user's desire to either power on or power off the phone. More importantly, the prior art does not provide a method to safeguard against unauthorized access to the mobile device based on the movement features.

The “wake up” function is usually integrated with identity authentication system that prevents unauthorized individuals from accessing the complete functions of the phone. Conventional methods of identity authentication used in smartphones include having to enter a 4 or 6-digit PIN or requiring the user to trace a user-defined gesture pattern on a 9-dot grid. Other methods of identity authentication now also utilize biometric inputs obtained from specific scanners or sensors that make up the smartphone.

However, all existing methods of locking and unlocking a smartphone come with significant drawbacks. The drawbacks of the unlocking or “wake up” methods are manifold. First, it requires the user to perform explicit actions that are time consuming and often complicated, requiring multiple steps before the unlocking can be completed. Second, having a PIN number means that memorization is required. If forgotten, even the true owner of the smartphone can be locked out. Third, if the individual owner of the smartphone chooses not to use additional identity authentication functions for the sake of convenience, unauthorized access to the smartphone cannot be prevented. Effectively, anyone will be able to use all the functions of the smartphone.

Even the simplistic shutdown or locking methods have drawbacks. The first drawback is the requirement that the explicit action of having to press a power button prior to shut down the smartphone. If a user forgets to do this, the phone display and the touchscreen remain active. For example, if a user forgets to push the power button before placing the smartphone in a bag or pocket, accidental calls could be placed or undesired messages (text and email) could be sent. The second drawback is that requiring a power down following a period of inactivity wastes battery life. In addition, the phone is vulnerable to unauthorized or accidental use during the time the phone is set aside if the power button is not pushed.

### BRIEF SUMMARY OF THE INVENTION

The objective of the invention is to provide mobile touch device users with a convenient method of powering on and powering off their mobile devices. The resulting state-of-the-art system is a safe and secure method of identifying themselves to gain access to their mobile device through the gesture-feature identification for the purpose of unlocking the smartphone device. The resulting state-of-the-art system also prevents accidental events where undesired or unwanted contacts with the start or power button leads to the mobile device being activated unnecessarily. Such accidental events can lead to battery power waste, messages or calls being made by mistake. In addition, conventional methods of waking up the smartphone using the push of the power button do not provide any level of security to reject unauthorized users.

The ensuing example embodiments of the present invention relate to the unlocking and locking of a smartphone using an algorithm that detects and evaluates the motions of the device in the hand that have been executed by an individual user. In an embodiment, the activation system recognizes that the smartphone should be unlocked by an individual's movement to bring the phone display into his or her eye view. In an embodiment, the deactivation system allows the smartphone to recognize that it should be locked and the display turned off when the individual performs a movement the either turns the phone face down or moves toward a position where it is to be placed in a bag or pocket. These forms of change in the position of the phone, detected by its sensors, indicate that the display is no longer visible to the user and the device is no longer needed.

The secure authentication of the identity of an individual is achieved via hand motions, executed by the individual with the smartphone in hand. In an embodiment, a system securely authenticates an individual based on the pattern of movement of the smartphone itself. A receiving module is configured to receive the motion of the smartphone and detect events that define situations where the phone should be locked or unlocked. This information is stored as movement data on the device. A comparing module is configured to authenticate the identity of the individual by comparing data from an input movement with previously captured movement data.

In an embodiment, a method provides for securely authenticating the identity of an individual using computer implemented algorithm that is able to rejected patterns of movement of the smartphone that are dissimilar to that of the true user. A movement pattern may be received from the individual generated by holding the smartphone in hand. The movement data may be detected and captured by sensor(s) built into the device. The authentication of the identity of the individual may be achieved by comparing the input movement data with previously captured movement data. In addition, the method of unlocking and locking the mobile device can be included and implemented as a component of a rapid response communication system, serving as a “visual walky-talky” system.

Various embodiments, including features and advantages of the various embodiments are described in detail below. The structure and operation of the various embodiments are described in detail below, alongside reference to the accompanying drawings.

### BRIEF DESCRIPTION OF THE SEVERAL VIEWS OF THE DRAWINGS

FIG. 1 is a schematic illustrating the first main scenario by which the smartphone device can be unlocked.

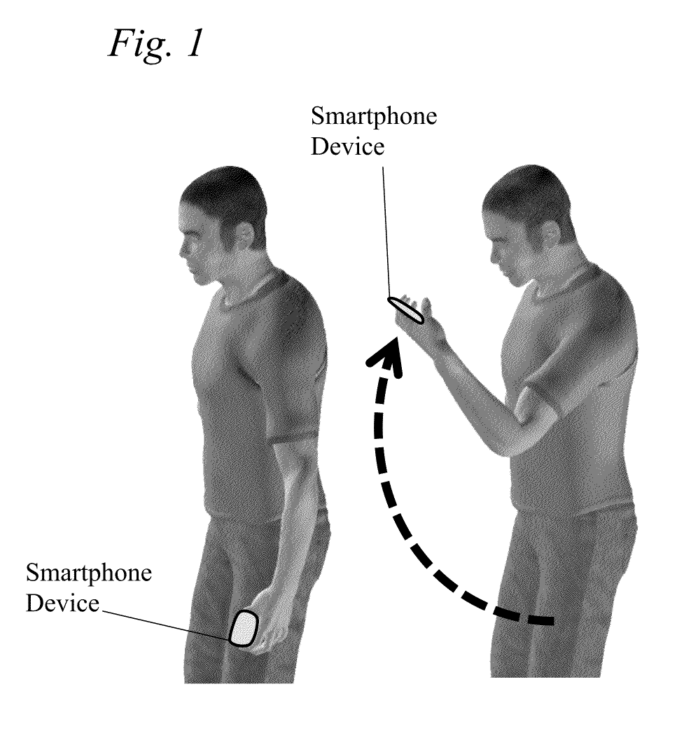

FIG. 2 is a schematic illustrating of the second main scenario by which the smartphone device can be unlocked.

FIG. 3 is a schematic illustrating a second series of steps taken when a first common scenario is carried out according to the invention.

FIG. 4 is a schematic illustrating a first series of steps taken when a second common scenario is carried out according to the invention.

These illustrations utilize specific terminology for the sake of clarity in describing the preferred embodiment of the invention as illustrated in the drawings. It is not however intended for the invention to be limited to the specific terminology that has been selected thus far, and it is to be understood that each specific term encompasses all technical equivalents that operate in a similar manner in order to accomplish a similar purpose. For example, the word identification or terms similar thereto are often used, and can be used interchangeably with other technically equivalent terms. These terms are not limited to user identification alone, but include user identification methods through other elements, for example, by rejecting non-users, where such identification is recognized as being equivalent by those skilled in the art.

### DETAILED DESCRIPTION OF THE INVENTION

The primary goal of the invention is to provide users with a “touchless” mode of interacting with their mobile device(s), primarily to control the locking and unlocking of the display. Apart from convenience, the invention provides users with a level of security, insofar as to reduce and potentially eliminate situations where a user forgets to lock their screen when the device is not in use, leading to either accidental placement of calls or unwanted messages from being sent. More importantly, leaving the screen of a mobile device unlocked is a security risk as it allows other users to gain access to sensitive personal data stored on the mobile device.

The embodiment presented here is the best mode of use, as contemplated for the current invention. There are two main scenarios in which the unlocking system is contemplated for use in the ordinary course, but others are contemplated for the variety of circumstances in which the invention is feasible. In the first of these two main scenarios, a person uses the system when removing his/her smartphone device from a static position in a bag or pocket. This is a common scenario when a smartphone user does not want to have use or direct access to their smartphone device and wishes to also conserve the life of the battery and touchscreen display. For use in the ordinary course, the user will move the device from the pocket or bag in an upward motion, holding it in hand and rotating the smartphone to a point in which the display is in a position where it is within the view of the user's eyes and the touchscreen surface is accessible for use.

The movement features of the smartphone can be detected by a receiving module that records the acceleration and rotation of the smartphone device in space. For the first unlocking scenario, the smartphone device moves along two primary axes of motion. The first is the Z-axis, which defines translation of the smartphone in the direction of the display. The second is the Y-axis, which defines translation of the phone along the length of the display. As the user's hand and arm extracts the smartphone from its resting position in the pocket or bag, it results in a sizeable translation and rotation of the smartphone device along the aforementioned axes. A consecutive, positive acceleration of the smartphone device along these two axes of motion is in an indicator that the phone should be unlocked.

When the user performs this action, the receiving module activates a comparator algorithm. The data derived from this activating input movement are then evaluated for comparison and authentication with a previously stored reference of the motions along the Y- and Z-axes of motion. If the movement satisfies the matching criteria, then the user is authenticated, and the phone is unlocked. If the requirements of the matching algorithm are not satisfied, the authentication fails and the smartphone remains locked. The user must perform the movement again in order to attempt to unlock the smartphone. Because of this, no memorization is required and the user simply needs to perform the movement naturally.

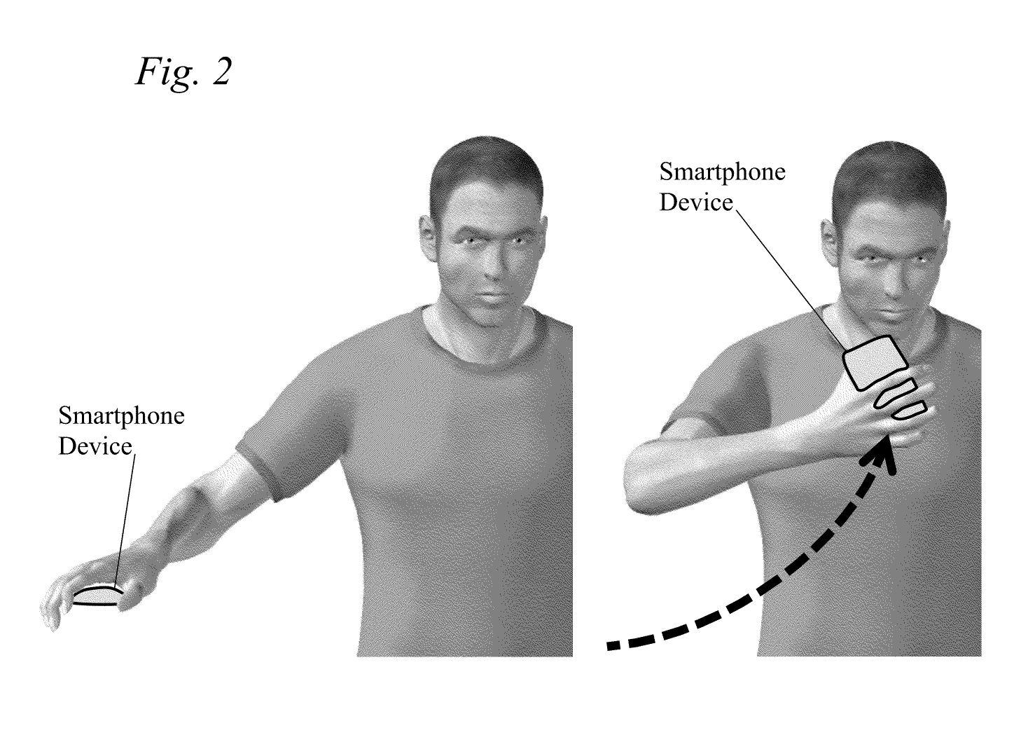

In the second of the two main scenarios, the smartphone is powered down with the display face down. This is another common scenario when a smartphone user does not want to have use or direct access to their smartphone device and wishes to also conserve the life of the battery and touchscreen display. For use in the ordinary course, the user will move the device from its resting, face down position on a flat surface, turning the display into a visible position. For the second unlocking scenario, the smartphone device moves along two primary axes of motion (FIG. 2). The first is the Z-axis, which defines translation of the smartphone in the direction of the display. The second is the X-axis, which defines translation of the phone along the width of the display. As the user's hand rotates the smartphone from its resting position on a table or desk, it results in a sizeable translation and rotation of the smartphone device along the aforementioned axes (FIG. 2). A consecutive, positive acceleration of the smartphone device along these two axes of motion is in an indicator that the phone should be unlocked.

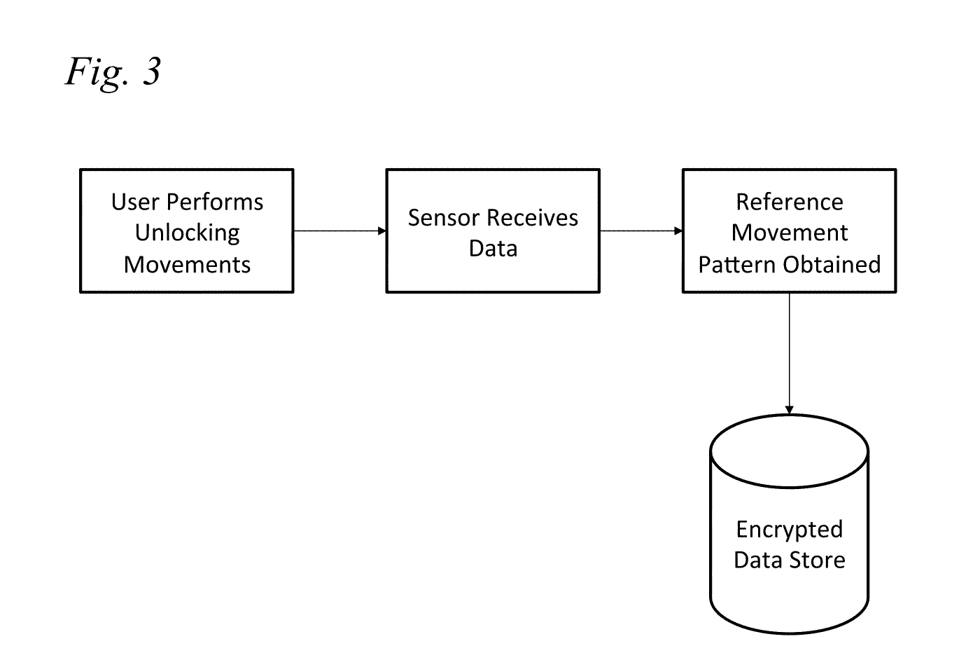

User identification may be conducted as part of the unlocking process as an additional component of the embodiment. There are two stages to the authentication process. First, a user profile must be generated. During this stage the user performs the movements required for each of the main unlocking scenarios repeatedly (for example, 5 to 10 repetitions). The data obtained from the accelerometer (or other motion sensor) are then collated and used to develop a reference data set. The reference data set may then be stored on the smartphone device in an encrypted form to further safeguard the data. The development of the reference set is illustrated in FIG. 3.

Whenever the specific user performs one of the actions as described by one of the two main unlocking scenarios, the receiving module activates a comparator algorithm. The data derived from this activating input movement are then evaluated for comparison and authentication with a previously stored reference with motion data from the X- and Z-axes of motion. If the movement satisfies the matching criteria, then the user is authenticated, and the phone is unlocked. If the requirements of the matching algorithm are not satisfied, the authentication fails and the smartphone remains locked. The user must perform the movement again in order to attempt to unlock the smartphone.

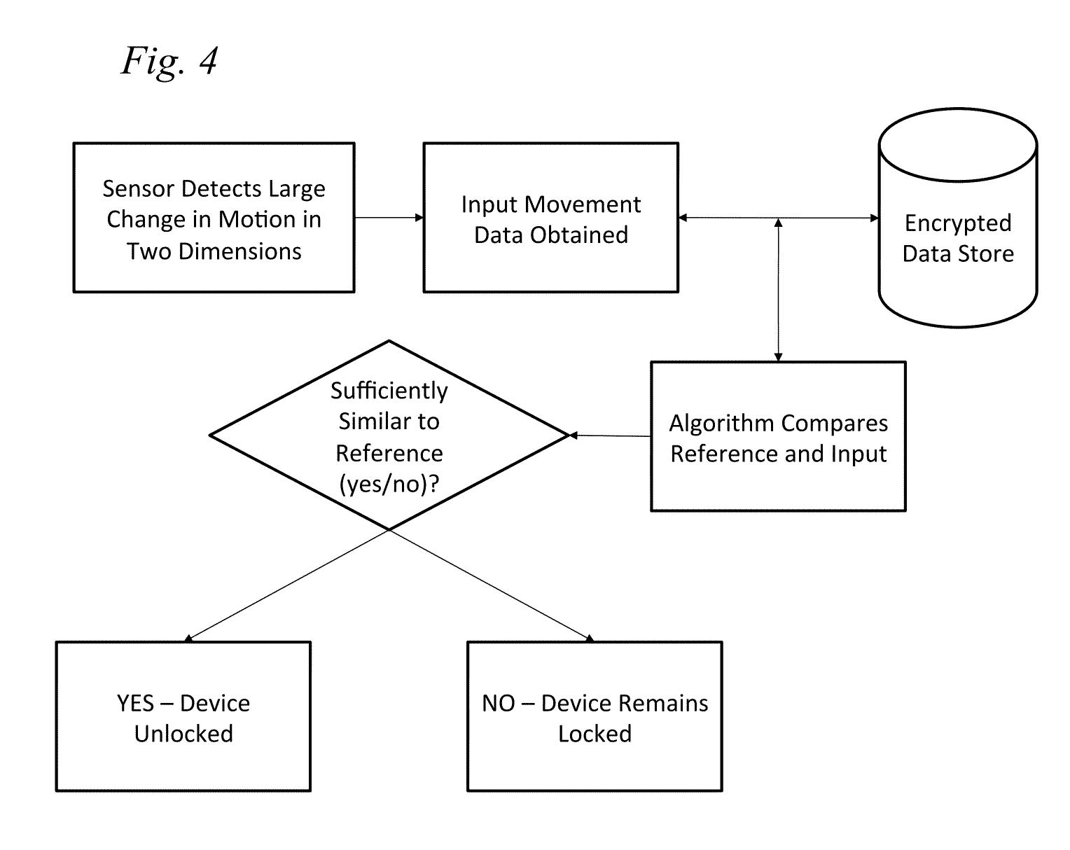

As the current invention is contemplated, in order for an input movement to be used to authenticate the user the following criteria must be satisfied. First, the rate of acceleration of the smartphone device along the predetermined axes of motion (Y and Z for the first main scenario, X and Z for the second main scenario) must be roughly, but not exactly similar. The pattern of acceleration could be allowed to vary by an empirically-determined threshold value, for example between +/−20% of the target values. The threshold can be dynamically adjusted by the algorithm. Second, the relationship between the accelerations along the two axes of motion must be maintained within a tolerance range. The relationship can be defined by (but not exclusively restricted to) acceleration values along the axes of motion, the absolute difference, or the relative difference between them, or their correlations. As an example, the Euclidean distance between all of the data pairs for the two axes of motion must be within twenty percent (20%) of the reference. Of course, these quantities can vary depending on the reliability of the sensors and other criteria that will be apparent to a person of ordinary skill based on the description of the invention herein. The process of user identification is illustrated in FIG. 4.

User identity authentication using static and dynamic methods of identification should be considered to be within the spirit and scope of the current invention. A static authentication process captures a single reference set and utilizes this data set for comparisons against all future inputs. As a result, static user identity authentication does not alter the reference set over time. A dynamic user identity authentication protocol can be applied where the authentication system continues to update itself with each subsequent successfully authenticated action for a given user.

User identity authentication is also not restricted to identifying a single user. A rejection-based approach, where the likelihood that the action was not generated by the authentic user of the smartphone device should be considered to be within the spirit and scope of this invention.

As accelerometer-gyroscope sensors become more sophisticated and increase in sensitivity, the above criteria can be expanded to other characteristics, especially in reference to body shape and size. The algorithm could be paired with other forms of physical biometric information, such as fingerprints, as part of the analysis. It is possible that in certain circumstances, to have more or less strict criteria for the matching algorithm and it is also contemplated to have more or fewer criteria under different circumstances. Additionally, the accelerometer-gyroscope is not the only method from which motion data can be extracted. The use of other forms of movement or motion tracking in a mobile device using the processes described here should be considered to be within the spirit and scope of the current invention.

The current invention may also be embodied as a component of a multi-factor user identity authentication system. For example, the current invention may be paired with other methods of user identification, such as, but not limited to, voice recognition, face recognition, fingerprints, PINS, and passwords. Such an alternative embodiment of the invention should be considered to within the spirit and scope of the invention.

Every time the system is used and the user is authenticated successfully, data from the input movement is stored in secured data storage, up to a predetermined maximum number of recorded authentic movements (for example, 10,000,000). A human-entered movement by the same user will not exactly duplicate any recorded entry, because of natural variations in human movement, even when executed by the same person. Because minimal amounts of data are stored, large numbers of trials can be maintained without affecting the functions of the smartphone device or burdening the memory storage.

Because the invention uses a fairly small number of matching criteria for the purpose of user identity authentication, a preferred embodiment is to protect the reference data using data encryption. Each sensor generated may have a unique key that provides every smartphone with a unique encryption method that cannot be reproduced on any other device. This preferred implementation protects the reference data from theft. With improvements in data security methods, it is possible that the reference movement data may be stored securely using software implementations or without encryption. These alternative embodiments should still be considered to be within the spirit and scope of the invention.

Indeed, situations where user identification is not included as a component of the invention should also be considered to be within the spirit and scope of the current invention. For example, if a user is in a “safe zone” where there is minimal risk of theft of the mobile device, the user may choose to forego the user identification component, allowing the embodied invention to function purely on the detection of the broader class of movements. This reduces computational costs and would reduce strain on the battery. The determination of safe zones can be conducted manually by the user, i.e., self-determined by the user on an ad hoc basis. Or, the determination of safety could be conducted automatically, for example, using location information obtained from a global positioning system or the detection that the mobile device is within range of one or more “friendly” WiFi signals.

For the purposes of locking the smartphone, there are also two main scenarios. In the first of these two main scenarios, a person uses the system when he/she no longer wants to use the smartphone device and wants to power down the display and device to save battery life and extend the life of the display. This is a common scenario where the ordinary user places the device into a secure location, most likely a pocket or a bag. For use in the ordinary course, the user will move the device to the pocket or bag in a downward motion, holding it in hand and rotating the smartphone to a point in which the smartphone is a static position, where there is minimal rotation of the device. Effectively, this first main scenario is the mirror opposite motion to that of the first main unlocking scenario. When the user performs this action, the receiving module activates a comparator algorithm. The data derived from this activating input movement is to detect whether the motions of the smartphone along the Y- and Z-axes of motion are in concert with a downward motion of the smartphone device and places the phone away. If the movement satisfies these criteria, the display is powered down and the phone becomes inactive.

A second main scenario for locking the smartphone is when the device is turned to a face down position, from an original position where the display is face up and held within eye view of the user. This is another common scenario when a smartphone user does not want to have use or direct access to their smartphone device and wishes to also conserve the life of the battery and touchscreen display. For use in the ordinary course, the user will move the device from a position where it is being used and turn it over to be face down on a surface. For the second locking scenario, the movement is the mirror opposite of the second main unlocking scenario. During this second locking scenario, the smartphone device moves along two primary axes of motion. The first is the Z-axis, which defines translation of the smartphone in the direction of the display. The second is the X-axis, which defines translation of the phone along the width of the display. As the user's hand rotates the smartphone toward its resting face down position on a stable surface, it results in a sizeable translation and rotation of the smartphone device along the aforementioned axes. If the movement satisfies the necessary criteria, then the phone is powered down.

The automated locking mechanism that responds directly to movement of the smartphone has direct benefits to the user. For example, if the individual user is in a hurry, he/she may forget to push the power button to power down the phone before placing it into a bag or pocket. At the minimum, this leads to wasted battery power and reduces the life of the display as the touchscreen remains active until sufficient time has passed. The amount of time required for the automatic shutdown of a smartphone due to inactivity is usually user defined and can last anywhere between one and five minutes. As a more risky situation, an active touchscreen would mean that all of the functions of the device can be activated by accidental contact with the surfaces of the bag or pocket while being jostled around. This can potentially lead to unwanted calls being placed or garbled text messages being sent. The invention removes this possibility by deactivating the touchscreen once there is a movement of the device to a position where it can no longer be used.

The best mode of implementation of the invention provided here involves a smartphone device. However, the scope of the current invention is not be limited to smartphone devices alone, and encompasses wearable mobile devices, for example, smartwatches that are worn on the wrist. Similar to the smartphone, the deliberate action of drawing the wrist up toward the face and turning the face of the watch to be visible is a similar process to that of moving the smartphone display to be within the visual space. Thus, the embodiment of the current invention using other mobile devices should be considered to be within the scope and spirit of the current invention.

An additional utility of the current invention is as a component of a rapid communication system, effectively, serving as a “visual walky-talky.” The screen unlocking function would allow important messages to be opened quickly with maximum convenience. In addition, the event of unlocking the display of the mobile device would provide a time-stamp to denote that the message has been read and received. Furthermore, user identification using the behavioral biometrics or multi-factor authentication would allow an indication that the appropriate individual has received a given message. Messages can be transmitted directly from device-to-device or through a physical or cloud-based server through a variety of methods of digital communication, for example but not exclusive to, radio frequency, near field communication, WiFi, cellular communication networks, all of which should be considered to be within the scope and spirit of the current invention.

This process is particularly convenient and functional in noisy environments, e.g., factories, power plants, or construction sites, where verbal communication is difficult. In addition, such contexts are often situations where use of the touchscreen is challenging because the device user's hands might be dirty or the wearing of gloves is essential. A touchless, gesture response, for example (but not exclusive to), vertical shaking of the device for “yes” and a sideways or horizontal shaking of the device for “no” could be employed, with the locking action with a lack of response indicating that the message has been ignored. Other gestures and forms of responses, e.g., verbal, touchscreen, etc. should be considered to be within the spirit and scope of this invention.

This detailed description in connection with the drawings is intended to provide a description of the presently best mode embodiments of the invention. This description is not intended to represent the only form of embodiments in which the present invention may be constructed or utilized. The description provides the preferred means and methods of implementing the invention in connection with the illustrated embodiments. Alternative embodiments may be adopted without departing from the invention or scope of the following claims, as it is to be understood that similar or equivalent functions and features may be accomplished by alternate or modified implementations that are also intended to be encompassed within the spirit and scope of the invention.

1. A method of unlocking a smartphone or wearable mobile device by a user, the method comprising:
the user presenting entering an input movement while holding the smartphone in hand or by moving a wearable mobile device, where the input movement has characteristics that can be recorded as a reference movement;

2. The method of claim 1, further comprising:
the reference movement representing a unique identifier for the user;
the user entering an input movement by moving the phone into an appropriate position;

3. The method of claim 2, further comprising:
a computer comparison of the pattern of movement and characteristics of the input movement against the pattern of movement and characteristics of the reference movement;

4. The method of claim 3, further comprising:
the user being authenticated and the unlocking of the smartphone if there are sufficient similarities between the pattern of movement and characteristics of the reference movement and the pattern of movement and characteristics of the input movement; and
the user being rejected, preventing the unlocking of the smartphone if there are insufficient similarities between the pattern of movement and characteristics of the reference movement and the pattern of movement and characteristics of the input movement, or if the pattern and characteristics of the input movement and between the pattern of movement and characteristics of the reference movement and the pattern of movement and characteristics of the reference movement match precisely; or if the pattern and characteristics of the input movement and between the pattern of movement and characteristics of the reference movement and the pattern of movement and characteristics of a prior input movement match precisely;

5. The method of claim 4, further comprising:
serving as part of a rapid communication system or “visual walky-talky” where message(s) transmitted to a smartphone or mobile device can be quickly opened using the described process.

6. A method of powering down and locking a smartphone by a user that is, turning off the display and touchscreen the method comprising:
the user presenting entering an input movement while holding the smartphone in hand, where the smartphone is moved into a position where the display is face down; or
the user presenting entering an input movement while holding the smartphone in hand, where the smartphone is moved into a static position where the display would not be visible to the user.
